(19) United States
(12) Patent Application Publication
(10) Pub. No.: US 2023/0188211 A1
(43) Pub. Date: Jun. 15, 2023

(54) NOTIFICATION SYSTEM, NOTIFICATION DEVICE, AND NOTIFICATION METHOD

(71) Applicant: NEC Corporation, Minato-ku,Tokyo (JP)

(72) Inventor: Taketo ONUMA, Tokyo (JP)

(73) Assignee: NEC Corporation, Minato-ku, Tokyo (JP)

(21) Appl. No.: 17/924,459

(22) PCT Filed: May 20, 2020
(86) PCT No.: PCT/JP2020/019845

§ 371 Date: Nov. 10, 2022

(51) Int. Cl. H04B 10/079; H04J 14/02

(52) U.S. Cl. CPC H04B 10/07955; H04J 14/02

(57) ABSTRACT

To provide a means that can notify a user, of a sub-band of a wavelength-multiplexed optical signal, regarding the occurrence of a problem, a notification system comprising: a detection means that receives a wavelength-multiplexed optical signal including a plurality of optical signals, and on the basis of an intensity of an optical signal in a sub-band allocated to the wavelength-multiplexed optical signal, detects the optical intensity in the sub-band; an identification means which, on the basis of the optical intensity in the sub-band, identifies a sub-band in which a problem has occurred; and a notification means that provides notification of the occurrence of the problem to a notification destination associated with the identified sub-band.

### TECHNICAL FIELD

The present invention relates to a notification system, a notification device, and a notification method that are capable of notifying a user of a sub-band of a wavelength-multiplexed optical signal, of occurrence of a problem.

### BACKGROUND ART

In a submarine optical cable system, a land terminal station transmits a wavelength-multiplexed optical signal in which optical signals having different wavelengths are multiplexed, to another terminal station via an optical fiber installed on the seabed. For example, PTLs 1 and 2 disclose a terminal station that transmits a wavelength-multiplexed optical signal.

In recent years, there is a case in which each sub-band divided from the entire band of a wavelength-multiplexed optical signal is allocated to each user. In this case, each user transmits an optical signal from a communication facility owned by each user, such as a data center, to a terminal station. Then, the terminal station multiplexes optical signals from the communication facilities of the users and outputs a wavelength-multiplexed optical signal.

### CITATION LIST

### Patent Literature

[PTL 1] Japanese Unexamined Patent Application Publication No. H11 (1999)-225115
[PTL 2] International Publication No. WO 2016/047089

### SUMMARY OF INVENTION

### Technical Problem

In such a case, when a problem such as an incorrect operation in the communication facility (for example, intensity of the optical signal transmitted from the communication facility to the terminal station is set incorrectly, and the like), and a failure such as disconnection in a transmission path from the communication facility to the terminal station, occurs, it is necessary to notify the user that the problem occurs. However, there has been no means for notifying the user of occurrence of the problem.

The present invention is made in view of the above-described problem, and an object of the present invention is to provide a means through which occurrence of a problem is able to be notified to a user of a sub-band of a wavelength-multiplexed optical signal.

### Solution to Problem

A notification system according to the present invention includes:
a detection means for receiving a wavelength-multiplexed optical signal including a plurality of optical signals, and detecting optical intensity in a sub-band allocated to the wavelength-multiplexed optical signal, based on intensity of the optical signal in the sub-band;
an identification means for identifying, based on optical intensity in the sub-band, the sub-band in which a problem has occurred; and
a notification means for notifying a notification destination associated with the identified sub-band, of occurrence of the problem.

Further, a notification device according to the present invention includes:
a detection means for receiving a wavelength-multiplexed optical signal including a plurality of optical signals, and detecting optical intensity in a sub-band allocated to the wavelength-multiplexed optical signal, based on intensity of the optical signal in the sub-band;
an identification means for identifying, based on optical intensity in the sub-band, the sub-band in which a problem has occurred; and
a notification means for notifying a notification destination associated with the identified sub-band, of occurrence of the problem.

Further, a notification method according to the present invention includes:
receiving a wavelength-multiplexed optical signal including a plurality of optical signals, and detecting optical intensity in a sub-band allocated to the wavelength-multiplexed optical signal, based on intensity of the optical signal in the sub-band;
identifying, based on optical intensity in the sub-band, the sub-band in which a problem has occurred; and
notifying a notification destination associated with the identified sub-band, of occurrence of the problem.

### Advantageous Effects of Invention

According to the present invention, it is possible to provide a means through which occurrence of a problem is able to be notified, to a user of a sub-band in a wavelength-multiplexed optical signal.

### BRIEF DESCRIPTION OF DRAWINGS

FIG. 1 is a block diagram illustrating a configuration example of a notification system according to a first example embodiment of the present invention.

FIG. 2 is a schematic diagram illustrating an optical spectrum for describing the notification system according to the first example embodiment the present invention.

FIG. 3 is a flowchart illustrating an operation example of the notification system according to the first example embodiment of the present invention.

FIG. 4 is a block diagram illustrating a configuration example of a notification system according to a second example embodiment of the present invention.

FIG. 5 is a flowchart illustrating an operation example of the notification system according to the second example embodiment of the present invention.

### EXAMPLE EMBODIMENT

### First Example Embodiment

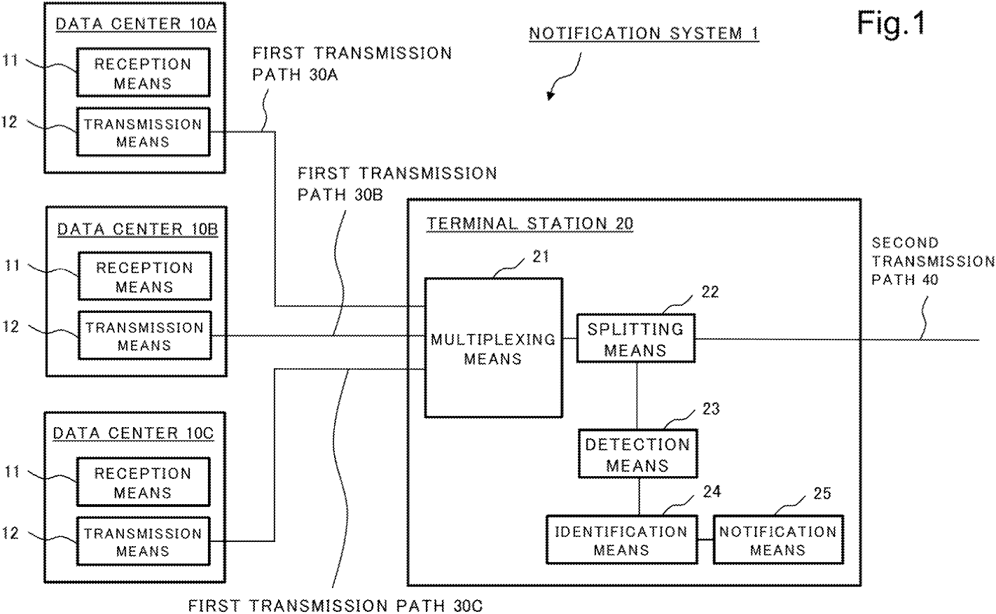

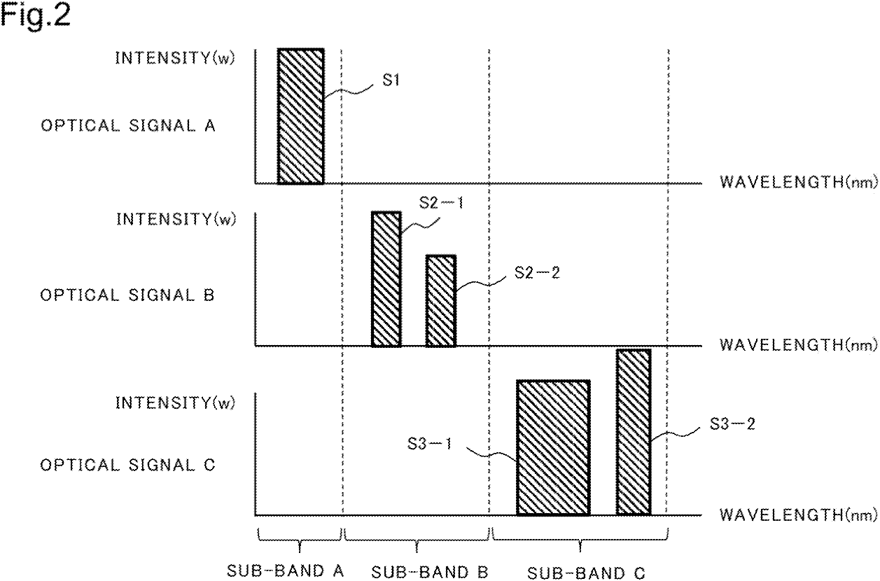

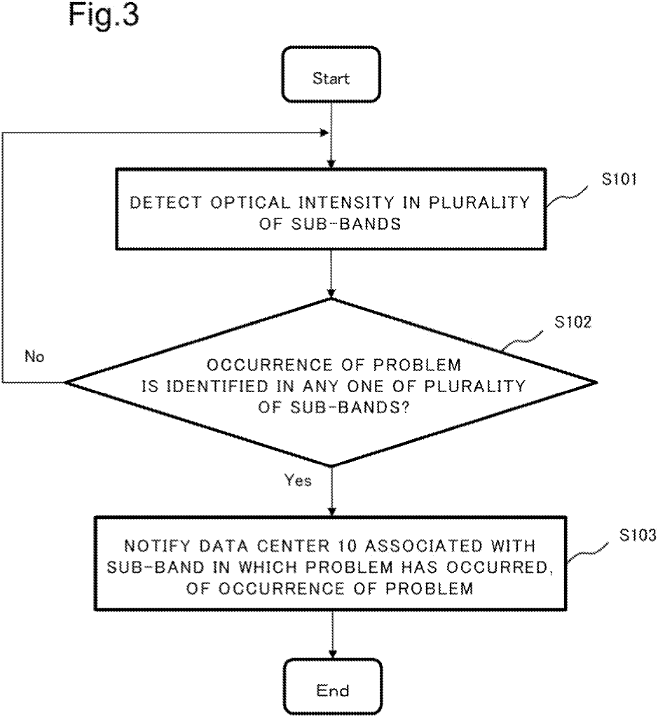

A notification system 1 according to a first example embodiment is described with reference to FIGS. 1, 2, and 3. FIG. 1 is a block diagram illustrating a configuration example of the notification system 1. FIG. 2 is a schematic diagram illustrating an optical spectrum for describing the notification system 1. FIG. 3 is a flowchart illustrating an operation of the notification system 1.

A configuration of the notification system 1 is described. As illustrated in FIG. 1, the notification system 1 includes data centers 10A, 10B, 10C, a terminal station 20, first transmission paths 30A, 30B, 30C, and a second transmission path 40. Note that, in the following description, when there is no need to distinguish each of the data centers 10A, 10B, and 10C, each of the data centers 10A, 10B, 10C is referred to as a data center 10. Further, when there is no need to distinguish each of the first transmission paths 30A, 30B, 30C, each of the first transmission paths 30A, 30B, 30C is referred to as a first transmission path 30.

A configuration of the data center 10 is described with reference to FIG. 1. The data center 10 includes a reception means 11 and a transmission means 12. The data center 10 is conned to the terminal station 20 via the first transmission path 30. Further, the data center 10 receives data from a communication device (not illustrated). Note that the data center 10 is not an essential component in the present example embodiment.

The reception means 11 receives, via a line (not illustrated), a notification from a notification means 25, which is described later. Further, contents of the notification are notified to a user of the data center 10. The notification to the user is achieved with, for example, textual notification using a monitor or audible notification using a speaker or an alarm.

The transmission means 12 converts the data received from the communication device (not illustrated) into an optical signal, and outputs the converted optical signal to the terminal station 20 via the first transmission path 30. At this occasion, each of the data centers 10A, 10B, and 10C outputs an optical signal having a wavelength in a sub-band that is different to one another. The transmission means 12 includes, for example, at least one optical transmitter.

FIG. 2 is a schematic diagram illustrating a spectrum shape of the optical signal output from the data center 10. In FIG. 2, a horizontal axis indicates wavelength, and a vertical axis indicates optical signal intensity. An optical signal A in a sub-band A in FIG. 2 is an optical signal output from the transmission means 12 of the data center 10A. Herein, the optical signal A is an optical signal S1. Further, an optical signal B in a sub-band B represents an optical signal output from the transmission means 12 of the data center 10B. Herein, the optical signal B is a wavelength-multiplexed optical signal including optical signals S2-1 and S2-2. Further, an optical signal C within a sub-band C represents an optical signal output from the transmission means 12 of the data center 10C. Herein, the optical signal C is a wavelength-multiplexed optical signal including optical signals S3-1 and S3-2.

A configuration of the terminal station 20 is described with reference to FIG. 1. As illustrated in FIG. 1, the terminal station 20 includes a multiplexing means 21, a splitting means 22, a detection means 23, an identification means 24, and a notification means 25. The terminal station 20 is connected to the data center 10 via the first transmission path 30. Further, the terminal station 20 is connected to another terminal station (not illustrated), via the second transmission path 40. The second transmission path 40 is, for example, an optical communication cable installed on a seabed.

The multiplexing means 21 multiplexes the optical signals from the data centers 10, and outputs a wavelength-multiplexed optical signal to the splitting means 22. The multiplexing means 21 is connected to the data center 10 via the first transmission path 30. The multiplexing means 21 is, for example, an optical coupler or a wavelength selective switch (WSS).

The splitting means 22 splits the wavelength-multiplexed optical signal output from the multiplexing means 21, and transmits the split wavelength-multiplexed optical signal to the second transmission path 40 and the detection means 23. The wavelength-multiplexed optical signal output to the second transmission path 40 is output to another terminal station (not illustrated). The splitting means 22 is, for example, an optical coupler.

The detection means 23 receives the wavelength-multiplexed optical signal including the plurality of optical signals, and detects optical intensity in a sub-band allocated for the wavelength-multiplexed optical signal, based on the intensity of the optical signal in the sub-band. The detection means 23 stores in advance a bandwidth of sub-bands such as the sub-bands A to C illustrated in FIG. 2.

The detection means 23 acquires, for example, by using an optical spectrum analyzer, a spectrum shape of the wavelength-multiplexed optical signal output from the splitting means 22. The detection means 23 detects the optical intensity in the sub-band, based on all optical signals in the sub-band. For example, the detection means 23 detects the optical intensity in the sub-band by totaling intensities of the optical signals in each sub-band. The optical spectrum analyzer detects a value of optical intensity at each unit wavelength by sweeping a bandwidth of the wavelength-multiplexed optical signal by each unit wavelength. The optical intensity is, for example, a value of optical energy expressed in watts (W). The above-described totaling is to add up the optical intensities at each unit wavelength in the sub-band, detected by the optical spectrum analyzer. For example, when the optical signals A, B, C illustrated in FIG. 2 are respectively output from the data centers 10, the detection means 23 detects optical intensity of the optical signal S1 as optical intensity in the sub-band A. Further, the detection means 23 outputs a value acquired by adding optical intensities of the optical signals S2-1 and S2-2 as optical intensity in the sub-band B.

The identification means 24 identifies, based on the optical intensity in each sub-band, the sub-band in which a problem has occurred. In the following, an example of a method of the identification is described.

In a first example, when the optical intensity in the sub-band including the optical signal satisfies a predetermined condition, the identification means 24 identifies the sub-band as a sub-band in which a problem has occurred. Specifically, when optical intensity in a sub-band is not within a range centered on a value set in advance for each sub-band, the identification means 24 identifies the sub-band as a sub-band in which a problem has occurred. The range set for each sub-band may be different for each sub-band.

In the first example, the value set for each sub-band is set based on transmission characteristics (for example, loss and the like) of the second transmission path 40 in the sub-band. For example, it is assumed that a loss in the second transmission path 40 in the sub-band A is greater than a loss in the second transmission path 40 in the sub-band B. In this case, in order to equalize optical intensities between the sub-bands at a time of reception, it is necessary to output a more intense optical signal to sub-band A, and therefore a value set for the sub-band A is higher than a value set for the sub-band B.

Note that, in the first example, when the sub-band in which a problem has occurred is identified, the identification means 24 also identifies a cause of the problem to be an incorrect operation on the transmission means 12 in each of the data centers 10.

In a second example, when no optical signal is detected in each sub-band, the identification means 24 identifies the sub-band as a sub-band in which a problem has occurred. In the second example, when a sub-band in which a problem has occurred is identified, the identification means 24 also identifies a cause of the problem to be a failure in the first transmission path 30 connecting the data center 10 that outputs an optical signal to the sub-band to the terminal station 20. For example, when no optical signal is detected in the sub-band A, the identification means 24 identifies that a cause of the problem is a failure in the first transmission path 30A connecting the data center 10A to the terminal station 20.

The notification means 25 notifies a notification destination associated with the sub-band identified by the identification means 24 of occurrence of the problem. Herein, the notification destination is, for example, the data center 10 of the user. The notification destination may be another communication facility including the reception means 11 and the transmission means 12. The notification means 25 is connected to the reception means 11 of the data center 10, via a line (not illustrated). For example, when the sub-band A is identified by the identification means 24, the notification means 25 transmits that a problem has occurred to the reception means 11 of the data center 10A, and thereby notifies a user of the data center 10A of occurrence of the problem. At this occasion, when a cause of the problem has been identified by the identification means 24, the notification means 25 may further notify contents of the cause.

Further, the notification means 25 notifies only the notification destination associated with the sub-band in which the problem has occurred of occurrence of the problem. For example, when the sub-band A is identified by the identification means 24, the notification means 25 notifies the data center 10A of occurrence of the problem, but does not notify the data centers 10B and 10C.

The configuration of the notification system 1 has been described above. Next, an operation example of the notification system 1 is described with reference to FIG. 3. Note that, at a start of the present operation example, it is assumed that the data center 10 has output an optical signal to the terminal station 20. Further, it is assumed that the detection means 23 stores in advance a bandwidth of each sub-band. Further, it is assumed that the identification means 24 stores in advance a range centered on a value set for each sub-band.

First, the detection means 23 receives a wavelength-multiplexed optical signal from the splitting means 22, and detects optical intensity in a sub-band included in the wavelength-multiplexed optical signal (S101).

The identification means 24 determines whether occurrence of a problem is identified in any of a plurality of sub-bands. For example, the identification means 24 identifies a sub-band in which a problem has occurred by using at least one of the above-described first and second examples of the identification method.

When a sub-band in which a problem has occurred is not identified (No in S102), processing in S101 is executed again.

When a sub-band in which a problem has occurred is identified (Yes in S102), the notification means 25 notifies the data center 10 (notification destination) that is associated with the sub-band in which a problem has occurred of occurrence of the problem. The operation of the notification system 1 has been described above.

As described above, the notification system 1 includes the detection means 23, the identification means 24, and the notification means 25. The detection means 23 receives a wavelength-multiplexed optical signal including a plurality of optical signals, and detects optical intensity in a sub-band allocated for the wavelength-multiplexed optical signal, based on the intensity of the optical signal in the sub-band. Further, the identification means 24 identifies, based on the optical intensity in the sub-band, a sub-band in which a problem has occurred. The notification means 25 notifies a notification destination associated with the identified sub-band of occurrence of the problem.

In such a way, in the notification system 1, occurrence of a problem is identified for each sub-band by the identification means 24. Further, when a problem occurs, the notification means 25 notifies a communication facility such as the data center 10 being the notification destination associated with the sub-band of occurrence of the problem. Therefore, in the notification system 1, occurrence of the problem is able to be notified to a user of the sub-band of the wavelength-multiplexed optical signal.

Further, in the notification system 1, the detection means 23 detects optical intensity in a sub-band, based on all optical signals in the sub-band. Thereby, even in a case in which a plurality of optical signals is output from a user-owned communication facility (for example, the data center 10) to a sub-band, the notification system 1 is able to detect optical intensity of the entire sub-band. Consequently, the notification system 1 is able to determine whether a problem has occurred, based on the optical intensity of the entire sub-band.

Further, when the optical intensity in the sub-band is not within the predetermined range, identification means 24 identifies the sub-band as a sub-band in which a problem has occurred. Thereby, when the optical intensity in the sub-band is not within the predetermined range, the notification system 1 is able to notify the notification destination such as the data center 10 of occurrence of the problem.

Further, the detection means 23 receives the wavelength-multiplexed optical signal including the optical signal output from the transmission means 12 of the notification destination. Further, the notification means 25 notifies the notification destination associated with the identified sub-band that a problem due to an incorrect operation on the transmission means 12 has occurred. Thereby, a user of the communication facility such as the data center 10, which is the notification destination, can recognize a cause of the problem.

Further, the detection means 23 receives a wavelength-multiplexed optical signal split from a wavelength-multiplexed optical signal output toward the second transmission path 40. Further, when the optical intensity in the sub-band is not within the range set according to the transmission characteristics of the second transmission path 40, the identification means 24 identifies the sub-band as a sub-band in which a problem has occurred. In this way, in the notification system 1, whether a sub-band has a problem is determined according to whether optical intensity in the sub-band is within the range set according to the transmission characteristics of the second transmission path 40. Therefore, for example, a sub-band having optical intensity higher than that of another sub-band in order to compensate a loss in the second transmission path 40 is not identified as a sub-band having a problem solely since the sub-band has higher optical intensity than the another sub-band.

Further, when no optical signal is detected in the sub-band, the identification means 24 identifies the sub-band as a sub-band in which a problem has occurred. Thereby, when no optical signal is detected in the sub-band, the notification system 1 is able to notify occurrence of a problem of the notification destination.

Further, the detection means 23 receives the wavelength-multiplexed optical signal including optical signals received via the first transmission path. Further, the notification means 25 notifies the notification destination associated with the identified sub-band that a problem due to a failure in the first transmission path 30 has occurred. Thereby, a user who received the notification can recognize a cause of the problem.

Further, the detection means 23 detects intensities of optical signals in a plurality of sub-bands allocated for the wavelength-multiplexed optical signal. Further, the notification means 25 notifies only the notification destination associated with the identified sub-band among the plurality of notification destinations associated with the plurality of sub-bands of occurrence of the problem. In this way, in the notification system 1, the notification means 25 notifies only the notification destination of the sub-band in which a problem has occurred of occurrence of the problem. Thereby, in the notification system 1, occurrence of the problem is able to be prevented from being notified to a user other than the user of the data center being the notification destination associated with the sub-band. For example, there is a case in which the first transmission path 30 connected to the transmission means 12 and the data center 10 is an asset owned by each user. In this case, each user has a demand that a status of their own asset not to be known to other companies. In the notification system 1, since occurrence of a problem is not notified to destinations other than the notification destination associated with the sub-band, the above-described demand is able to be satisfied.

### Second Example Embodiment

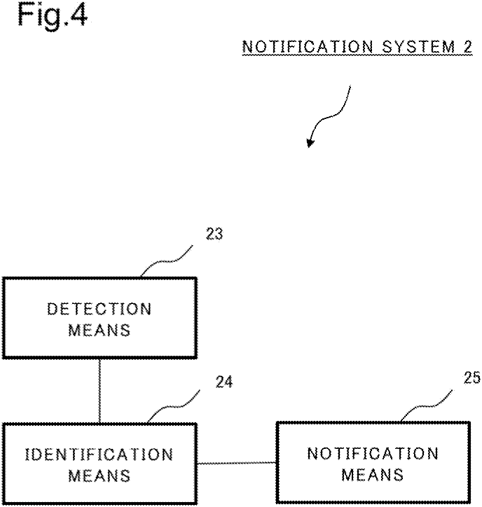

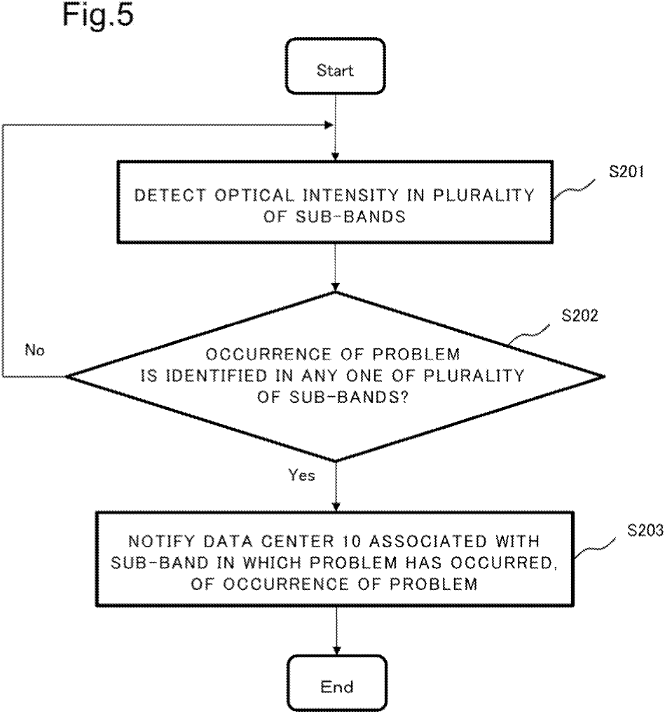

A notification system 2 according to a second example embodiment is described with reference to FIGS. 4 and 5. As illustrated in FIG. 4, the notification system 2 includes a detection means 23, an identification means 24, and a notification means 25.

The detection means 23 receives a wavelength-multiplexed optical signal including a plurality of optical signals. Further, the detection means 23 detects optical intensity in a sub-band allocated for the received wavelength-multiplexed optical signal, based on the intensity of the optical signal in the sub-band.

The identification means 24 identifies, based on the optical intensity in the sub-band, a sub-band in which a problem has occurred. For example, the identification means 24 identifies the sub-band in which a problem has occurred by using at least one of the first and second examples of the identification method in the notification system 1 according to the first example embodiment.

The notification means 25 notifies a notification destination associated with the identified sub-band of occurrence of the problem.

Note that, in the notification system 2, the detection means 23, the identification means 24, and the notification means 25 may have a configuration, a function, and a connection relationship similar to those of the notification system 1 according to the first example embodiment. A configuration of the notification system 2 has been described above.

Next, an operation example of the notification system 2 is described with reference to FIG. 5. Note that, at a start of the present operation example, it is assumed that the detection means 23 has received a wavelength-multiplexed optical signal from outside. Further, it is assumed that the detection means 23 stores in advance a bandwidth of a sub-band allocated for the wavelength-multiplexed optical signal.

First, the detection means 23 receives the wavelength-multiplexed optical signal from outside, and detects optical intensity in a sub-band included in the wavelength-multiplexed optical signal (S201).

The identification means 24 determines whether occurrence of a problem is identified in any one of a plurality of the sub-bands. For example, the identification means 24 identifies a sub-band in which a problem has occurred by using at least one of the first and second examples of the method for identifying a sub-band in the notification system 1. Note that, when the identification means 24 identifies the sub-band by using the method exemplified in the first example, it is assumed that the identification means 24 stores in advance a range centered on a value set for each sub-band.

When a sub-band in which a problem has occurred is not identified (No in S202), the processing in S201 is executed again.

When a sub-band in which a problem has occurred is identified (Yes in S202), the notification means 25 notifies a data center 10 associated with the sub-band in which a problem has occurred of occurrence of the problem. The operation of the notification system 2 has been described above.

As described above, the notification system 2 includes the detection means 23, the identification means 24, and the notification means 25. The detection means 23 receives a wavelength-multiplexed optical signal including a plurality of optical signals, and detects optical intensity in a sub-band allocated for the wavelength-multiplexed optical signal, based on the intensity of the optical signal in the sub-band. Further, the identification means 24 identifies, based on the optical intensity in the sub-band, a sub-band in which a problem has occurred. The notification means 25 notifies a notification destination associated with the identified sub-band of occurrence of the problem.

In this way, in the notification system 2, occurrence of a problem is identified for each sub-band by the identification means 24. Further, when a problem occurs, occurrence of the problem is notified, by the notification means 25, to a notification destination (data center 10) associated with the sub-band. Therefore, in the notification system 2, occurrence of the problem is able to be notified to a user of the sub-band of the wavelength-multiplexed optical signal.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Reference signs List

| | |
|---|---|
| 1, 2 | Notification system |
| 10, 10A, 10B, 10C | Data center |
| 11 | Reception means |
| 12 | Transmission means |
| 20 | Terminal station |
| 21 | Multiplexing means |
| 22 | Splitting means |
| 23 | Detection means |
| 24 | Identification means |
| 25 | Notification means |
| 30, 30A, 30B, 30C | First transmission path |
| 40 | Second transmission path |

What is claimed is:

1. A notification system comprising:
a detector configured to receive a wavelength-multiplexed optical signal including a plurality of optical signals, and detect optical intensity in a sub-band allocated to the wavelength-multiplexed optical signal, based on intensity of the optical signal in the sub-band;
an identificator configured to identify, based on optical intensity in the sub-band, the sub-band in which a problem has occurred; and
a notificator configured to notify a notification destination associated with the identified sub-band, of occurrence of the problem.

2. The notification system according to claim 1, wherein the detector detects the optical intensity in the sub-band, based on all optical signals in the sub-band.

3. The notification system according to claim 1, wherein the identificator identifies, when the optical intensity in the sub-band including the optical signal satisfies a predetermined condition, the sub-band as the sub-band in which a problem has occurred.

4. The notification system according to claim 3, wherein
the detector receives the wavelength-multiplexed optical signal including the optical signal being output from transmission means of the notification destination, and
the notificator notifies the notification destination associated with the identified sub-band that a problem due to incorrect operation on the transmission means has occurred.

5. The notification system according to claim 3, wherein
the detector receives a wavelength-multiplexed optical signal split from a wavelength-multiplexed optical signal being output to a second transmission path, and
the identificator identifies, when the optical intensity in the sub-band satisfies a condition being set according to a transmission characteristic of the second transmission path, the sub-band as the sub-band in which a problem has occurred.

6. The notification system according to claim 1, wherein the identificator identifies, when the optical signal in the sub-band is not detected, the sub-band as the sub-band in which a problem has occurred.

7. The notification system according to claim 6, wherein
the detector receives a wavelength-multiplexed optical signal including an optical signal received via a first transmission path, and
the notificator notifies the notification destination associated with the identified sub-band that a problem due to a failure in the first transmission path has occurred.

8. The notification system according to claim 1, wherein
the detector detects intensity of the optical signal in a plurality of sub-bands allocated to the wavelength-multiplexed optical signal, and
the notificator notifies only a notification destination associated with the identified sub-band among a plurality of notification destinations associated with the plurality of sub-bands, of occurrence of the problem.

9. A notification device comprising:
a detector configured to detect a wavelength-multiplexed optical signal including a plurality of optical signals, and detect optical intensity in a sub-band allocated to the wavelength-multiplexed optical signal, based on intensity of the optical signal in the sub-band;
an identificatory configured to identify, based on optical intensity in the sub-band, the sub-band in which a problem has occurred; and
a notificator configured to notify,a notification destination associated with the identified sub-band, of occurrence of the problem.

10. A notification method comprising:
receiving a wavelength-multiplexed optical signal including a plurality of optical signals, and detecting optical intensity in a sub-band allocated to the wavelength-multiplexed optical signal, based on intensity of the optical signal in the sub-band;
identifying, based on optical intensity in the sub-band, the sub-band in which a problem has occurred; and
notifying a notification destination associated with the identified sub-band, of occurrence of the problem.
